(19) United States
(12) Patent Application Publication
(10) Pub. No.: US 2006/0244377 A1
(43) Pub. Date: Nov. 2, 2006

(54) Electroluminescent light source

(76) Inventor: Eugene Mushtaev, San Francisco, CA (US)

Correspondence Address: Ilya Zborovsky, 6 Schoolhouse Way, Dix Hills, NY, 11746, US

(21) Appl. No.: 11/118,889

(22) Filed: May 2, 2005

(51) Int. Cl. H05B 33/00; H01J 1/62

(52) U.S. Cl. 313/511

(57) ABSTRACT

An electroluminescent light source has an elongated insulating transparent polymer sheaths having a longitudinal axis; a plurality of electrodes extending along the longitudinal axis of the sheath and connectable to a power source; a plurality of electroluminescent layers each at least partially surrounding a respective one of the electrodes, each of the electrodes having an outer surface which is at least partially surrounded by a respective one of the electroluminescent layers and being provided with a light reflecting coating.

### BACKGROUND OF THE INVENTION

The present invention relates to an electroluminescent light source.

Electroluminescent light sources are known in the art and used in lighted decorations, lighted advertising, show business, optical data display, cinematography, photography, modern art, new consumer lighting products, medicine, light alarm systems, as well as for light tracing of dark spaces, and for many other applications. Some electroluminescent lights are disclosed in U.S. Pat. Nos. 2,684,450; 2,838,715; 2,918,594; 2,928,015; 3,023,338; 3,052,812; 3,278,784; 3,571,647; and our U.S. Pat. No. 5,959,402.

It is believed that the existing electroluminescent light sources can be further improved, in particular to provide a possibility of reducing or increasing diameters and increasing brightness of light generated by the electroluminescent light sources.

### SUMMARY OF THE INVENTION

Accordingly, it is an object of the present invention to provide an electroluminescent light source which is a further improvement of the existing light sources of this type.

In keeping with these objects and with others which will become apparent hereinafter, one feature of the present invention resides, briefly stated, in an electroluminescent light source which has an elongated insulating transparent polymer sheath having a longitudinal axis; a plurality of electrodes extending along said longitudinal axis of said sheath and connectable to a power source; a plurality of electroluminescent layers each at least partially surrounding a respective one of said electrodes, each of said electrodes having an outer surface which is at least partially surrounded by a respective one of said electroluminescent layers and being provided with a light reflecting coating.

In accordance with another feature of the present invention, the electroluminescent light source has a plurality of transparent dielectric layers each located between one of said electrodes and a respective one of said electroluminescent layers which surround said one electrode, each of said light reflective layers being located between an outer surface of a respective one of said electrodes and an inner surface of a respective one of said transparent dielectric layers.

In accordance with a further feature of the present invention, in the electroluminescent light source said electrodes are subdivided into a plurality of groups each including a plurality of said electrodes, said electrodes of each of said groups being connected with one another; and further means is provided for connecting said electrodes with one another in each of said groups.

In accordance with still a further feature of the present invention, in the electroluminescent light source sheath is formed as a tube having a wall, and said electrodes being located in said wall and spaced from one another in a circumferential direction around said longitudinal axis.

In accordance with still a further feature of the present invention, in the electroluminescent light source the tubular sheath has an inner-surface; and a light reflecting layer is provided on said inner surface of said sheath and reflecting light through said sheath radially outwardly.

In accordance with an additional feature of the present invention, in the electroluminescent light source insulating transparent polymer sheath is formed as a solid elongated member, said electrodes being arranged in an interior of said elongating member and spaced from one another substantially in a direction transverse to said longitudinal axis.

In accordance with still an additional feature of the present invention, in the solid elongated member, said electrodes being arranged in several groups located in an interior of said elongated member so that said groups of said electrodes are spaced from one another.

In accordance with still an additional feature of the present invention, in the electroluminescent light source the groups of said electrodes in a cross-section of said insulating transparent polymer sheath are arranged in a substantially triangular fashion.

In accordance with the supplemental feature of the present invention, of electroluminescent layers have different colors along portions which follow one another in a direction of said longitudinal axis or around the longitudinal axis.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a cross-section of an electroluminescent light source in accordance with one embodiment of the present invention;

FIGS. 2a and 2b are view showing the electroluminescent light source in accordance with another embodiment of the present invention;

FIG. 3 is a view showing a cross-section of an electroluminescent light source in accordance with a further embodiment of the present invention;

FIG. 4 is a view showing a cross-section of an electroluminescent light source in accordance with still a further feature of the present invention.

### DESCRIPTION OF THE PREFERRED EMBODIMENTS

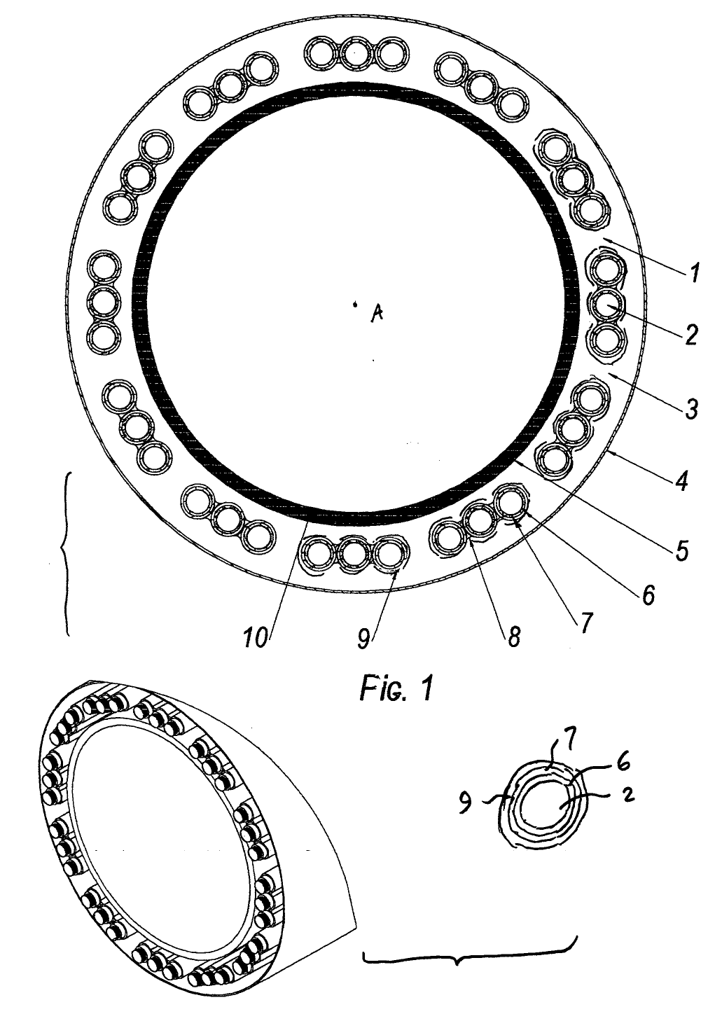

An electroluminescent light source in accordance with one embodiment of the present invention is shown in FIG. 1.

The inventive electroluminescent light source has an insulating transparent polymer sheath which is identified as a whole with reference numeral 1. The electroluminescent transparent polymer sheath can be composed of any material, for example of polyurethane, etc.

In the embodiment shown in FIG. 1, the insulating transparent polymer sheath is formed as a tubular element.

The electroluminescent light source in accordance with the present invention is further provided with a plurality of electrodes which are identified with reference numeral 2. The electrodes 2 are incorporated in a tubular wall of the insulating transparent polymer sheath 1, which has an outer surface 4 and an inner surface 5. As can be seen from the drawings, the electrodes 2 are distributed in a circumferential direction around a longitudinal axis A of the tubular insulating transparent polymer sheath.

In the shown embodiment the electrodes are arranged in several groups which are distributed, substantially uniformly, over a circumference around the longitudinal axis A. Each group can be composed of for example three electrodes 2. The electrodes 2 are connectable to an electric current source through a corresponding equipment, which is not described herein in detail and corresponds to that disclosed in our U.S. Pat. No. 5,959,402 which is incorporated here by reference.

Each of the electrodes 2 is surrounded by an electroluminescent layer 9, at least partially, but preferably completely around an outer circumference of the electrode 2. In order to prevent short circuiting, the electrodes 2 are covered by a transparent dielectric layer 7 composed for example of a polyester and the like. The transparent dielectric layers 7 prevent short circuiting between two neighboring electrodes. It is believed that it is possible to cover only each second electrode 2 with a transparent dielectric layer 7, to avoid short circuiting.

In each of the groups the electrodes are connected with one another by a connecting layer 8 which can be composed for example of epoxy adhesive, polyurethane adhesive and the like.

In accordance with the present invention the outer surface of each electrode is provided with a light reflecting layer or substance identified with reference numeral 6. For example, the reflective layer 6 can be composed of silver, nickel, and the like.

Finally, in accordance with still a further feature of the present invention, the inner surface 5 of the insulating transparent polymer sheath 1 is covered by a light reflecting layer, which can be composed of any light-reflecting material. The layer 10 has a reflecting surface facing radially outwardly toward the electrodes 2.

When electric current is supplied through the electrodes 2, an electric field is generated by the neighboring electrodes, and electroluminescent light is produced in the electroluminescent layers 9 surrounding the electrodes, which is visible from a side of the outer surface 4 of the insulating transparent polymer sheath 1. The light-reflecting layers 7 on the outer surface of the electrodes 2 reflect light emitted by grains of electroluminescent material of the electroluminescent layers 9 from the surface of the electrodes, and therefore brightness of light emission of the outer surface of the insulating transparent polymer sheaths increases. Electroluminescent light which is emitted by radially inner portions of the electroluminescent layers 6 facing toward the axis A is reflected by the light reflecting layer 10 radially outwardly as well, so as to intensify the light emitted by the electroluminescent light source in accordance with the present invention.

In accordance with further features of the present invention, pigment can be introduced into the material of the insulating transparent polymer sheath in order to increase effect of light dispersion. Also, electroluminescent grains can be also introduced into the insulating transparent polymer sheath 1 to increase electroluminescent light emitting effect.

The insulating transparent polymeric sheath 1 is formed so that it is flexible, and therefore the whole electroluminescent light source is flexible as well.

In accordance with another feature of the present invention, the electrodes can be covered with such electroluminescent layers 9′ which have several portions extending in the direction of the longitudinal axis A and having different colors, thus creating an effect of a running light. Also, the electroluminescent layers 6 around the respective electrode 2 can have portions spaced from one another in a circumferential direction and producing lights of different colors, thus creating the running light effect as well, but in a circumferential direction. Both versions are combinable with one another.

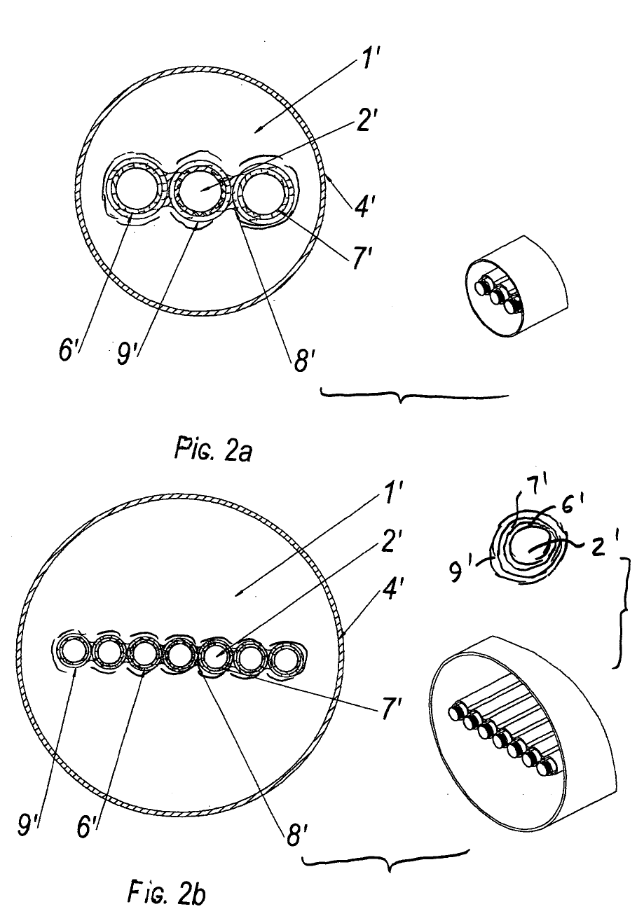

In the embodiment shown in FIGS. 2a and 2b, the insulating transparent polymer sheath is identified with reference numeral 1′ and is formed as a solid, elongated rod-shaped element. The electrodes 2′ which can be formed as in the embodiment shown in FIG. 1 and covered with the same layers, are located in an interior of the solid insulating transparent polymeric sheath 1′ and spaced from one another, for example in a substantially radial direction. FIG. 2a shows 3 electrodes, while FIG. 2b shows 7 electrodes.

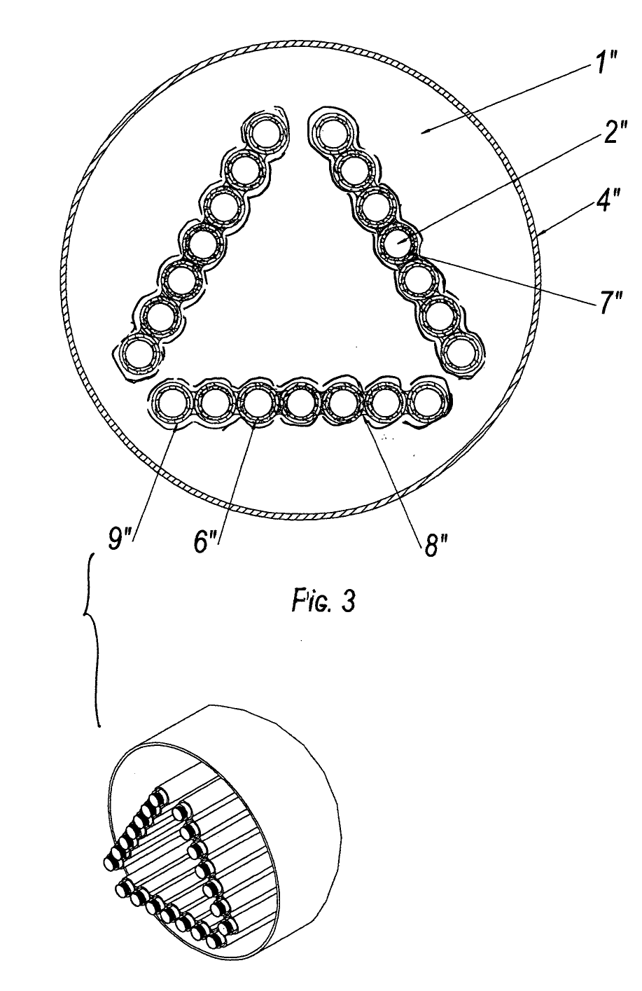

In another embodiment shown in FIG. 3, the insulating transparent polymeric sheath is identified with reference numeral 1″ and is also formed as a solid element. Several groups of the electrodes 2″ which can be similar to the electrodes shown in FIG. 1 and covered with the same layers, are spaced from one another substantially in a circumferential direction. In a particular embodiment, the groups can be arranged in a substantially triangular pattern in the interior of the solid insulating transparent polymer sheath 1″.

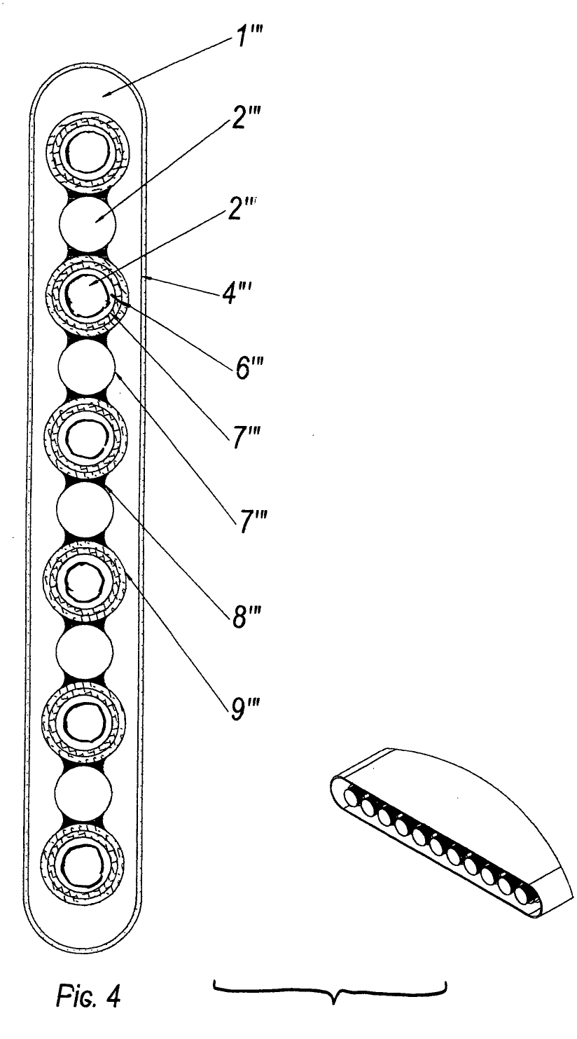

In a further embodiment shown in FIG. 4, the insulating transparent polymer sheath identified with reference numeral 1′″ is formed as a substantially flat band. It is provided with a plurality of electrodes 2′″ having an outer light reflecting layer 7′″, a transparent electric layer 9′″, and an outer electroluminescent layer 6′″. In addition, between two neighboring electrodes, additional electrodes 2″ are provided. These additional electrodes do not have a transparent dielectric layer or an electroluminescent layer but are provided with a light reflecting layer 7′″. This further increases brightness of light emission by the inventive electroluminescent light source.

It will be understood that each of the elements described above, or two or more together, may also find a useful application in other types of constructions differing from the types described above.

While the invention has been illustrated and described as embodied in electroluminescent light source, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An electroluminescent light source, comprising an elongated insulating transparent polymer sheaths having a longitudinal axis; a plurality of electrodes extending along said longitudinal axis of said sheath and connectable to a power source; a plurality of electroluminescent layers each at least partially surrounding a respective one of said electrodes, each of said electrodes having an outer surface which is at least partially surrounded by a respective one of said electroluminescent layers and being provided with a light reflecting coating.

2. An electroluminescent light source as defined in claim 1; and further comprising a plurality of transparent dielectric layers each located between one of said electrodes and a respective one of said electroluminescent layers which surround said one electrode, each of said light reflective layers being located between an outer surface of a respective one of said electrodes and an inner surface of a respective one of said transparent dielectric layers.

3. An electroluminescent light source as defined in claim 1, wherein said electrodes are subdivided into a plurality of groups each including a plurality of said electrodes, said electrodes of each of said groups being connected with one another; and further comprising means for connecting said electrodes with one another in each of said groups.

4. An electroluminescent light source as defined in claim 1, wherein said sheath is formed as a tube having a wall, said electrodes being located in said wall and spaced from one another in a circumferential direction around said longitudinal axis.

5. An electroluminescent light source as defined in claim 4, wherein said tube has an inner surface; and further comprising a light reflecting layer provided on said inner surface of said tube and reflecting light through said sheath radially outwardly.

6. An electroluminescent light source as defined in claim 1, wherein said insulating transparent polymer sheath is formed as a solid elongated member, said electrodes being arranged in an interior of said elongating member and spaced from one another substantially in a direction transverse to said longitudinal axis.

7. An electroluminescent light source as defined in claim 1, wherein said insulating transparent polymer sheath is formed as a solid elongated member, said electrodes being arranged in several groups located in an interior of said elongated member so that said groups of said electrodes are spaced from one another.

8. An electroluminescent light source as defined in claim 7, wherein said groups of said electrodes in a cross-section of said insulating transparent polymer sheath are arranged in a substantially triangular fashion.

9. An electroluminescent light source as defined in claim 1, wherein at least one of said electroluminescent layers have different colors along portions which follow one another in a direction of said longitudinal axis.

10. An electroluminescent light source as defined in claim 1, wherein at least-one of said electroluminescent layers have different colors along portions located in a circumferential direction around an axis of a respective one said electroluminescent layers.

11. An electroluminescent light source as defined in claim 1, wherein said insulating transparent polymer sheath is flexible.

12. An electroluminescent light source as defined in claim 1; and further comprising a pigment incorporated in said insulating transparent polymer sheath for increasing a dispersion light effect.

13. An electroluminescent light source as defined in claim 1; and further comprising a plurality of electroluminescent grains incorporated in said insulating transparent polymer sheath for increasing an electroluminescent effect.
